(19) United States
(12) Patent Application Publication
(10) Pub. No.: US 2009/0218843 A1
(43) Pub. Date: Sep. 3, 2009

(54) LONGITUDINAL ADJUSTMENT APPARATUS FOR A VEHICLE SEAT

(75) Inventors: Michael Wojatzki, Ennigerloh (DE); Klaus Walter, Paderborn (DE); Joerg Sternberg, Rheda-Wiedenbru (DE); Andre Schebaum, Steinhagen (DE); Marc Laumeier, Langenberg (DE); Hans-Peter Mischer, Bad Meinberg (DE)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 12/326,397

(22) Filed: Dec. 2, 2008

(30) Foreign Application Priority Data
Feb. 28, 2008 (DE) 10 2008 011 759.5
Jul. 25, 2008 (DE) 10 2008 034 788.4

(51) Int. Cl. B60N 2/07; B60N 2/06; B60N 2/08

(52) U.S. Cl. 296/65.13; 248/429

(57) ABSTRACT

A longitudinal seat adjustment apparatus for a vehicle seat includes a first support member that is attachable to a vehicle, and a second support member that is moveable with respect to the first support member and configured to support the seat such that the seat is movable with the second support member. One of the support members has first and second lock portions that face each other, and the other support member has a third lock portion that is configured to be located between the first and second lock portions. The apparatus further includes a locking member that is movable generally vertically with respect to the support members between a locked position and an unlocked position for locking and unlocking the second support member with respect to the first support member. When the locking member is in the locked position, the locking member extends into the first, second and third lock portions.

### CROSS-REFERENCE TO RELATED APPLICATIONS

This application claims foreign priority benefits under 35 U.S.C. §119(a)-(d) to DE 10 2008 011 759.5, filed Feb. 28, 2008 and DE 10 2008 034 788.4, filed Jul. 25, 2008, which are hereby incorporated by reference in their entirety.

### BACKGROUND OF THE INVENTION

1. Field of the Invention

The invention relates to a longitudinal adjustment apparatus for a vehicle seat, and to a seat assembly including such an apparatus.

2. Background Art

A vehicle seat assembly may include a seat supported on a longitudinal adjustment apparatus that enables the seat to be positioned in multiple longitudinal positions. U.S. Pat. No. 6,126,133 discloses an example of such an apparatus.

### SUMMARY OF THE INVENTION

In one embodiment, a longitudinal seat adjustment apparatus for a vehicle seat includes a first support member that is attachable to a vehicle, and a second support member that is moveable with respect to the first support member and configured to support the seat such that the seat is movable with the second support member. One of the support members has first and second lock portions that face each other, and the other support member has a third lock portion that is configured to be located between the first and second lock portions. The apparatus further includes a locking member that is movable generally vertically with respect to the support members between a locked position and an unlocked position for locking and unlocking the second support member with respect to the first support member. When the locking member is in the locked position, the locking member extends into the first, second and third lock portions.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 shows an exemplary vehicle seat assembly including a seat back pivotally attached to a seat bottom, and a longitudinal seat adjustment apparatus that supports the seat bottom and seat back;

FIG. 2 is a top perspective view of a portion of the seat adjustment apparatus;

FIG. 3a is a side cross-sectional view of a portion of the seat adjustment apparatus showing upper and lower rails, a locking device for locking the upper rail with respect to the lower rail, and a release mechanism for unlocking the locking device;

FIG. 3b is a side cross-sectional view similar to FIG. 3a showing the locking device in an unlocked position;

FIG. 4 is a side view of another exemplary embodiment of a locking device;

FIG. 5 is a perspective view of the seat adjustment apparatus, with the rails partially broken away to show the release mechanism;

FIG. 6 is a perspective cross-sectional view of the seat adjustment apparatus;

FIG. 7 is a cross-sectional end view of the rails;

FIG. 8 is a plan cross-sectional view of the seat adjustment apparatus showing a locking member of the locking device;

FIG. 9 is a cross-sectional view taken along line 9-9 in FIG. 8 and viewed in the direction of the arrows;

FIG. 10 is a cross-sectional view taken along line 10-10 in FIG. 8 and viewed in the direction of the arrows;

FIG. 11 is a cross-sectional view taken along line 11-11 in FIG. 8 and viewed in the direction of the arrows;

FIG. 12 is a plan view of another exemplary locking member;

FIG. 13 is a side cross-sectional view of a portion of another exemplary lower rail for use with the locking member of FIG. 12;

FIG. 14 is a side cross-sectional view of a portion of another exemplary upper rail for use with the locking member of FIG. 12; and

FIG. 15 is a side cross-sectional view of portions of the locking member and rails assembled together.

### DETAILED DESCRIPTION

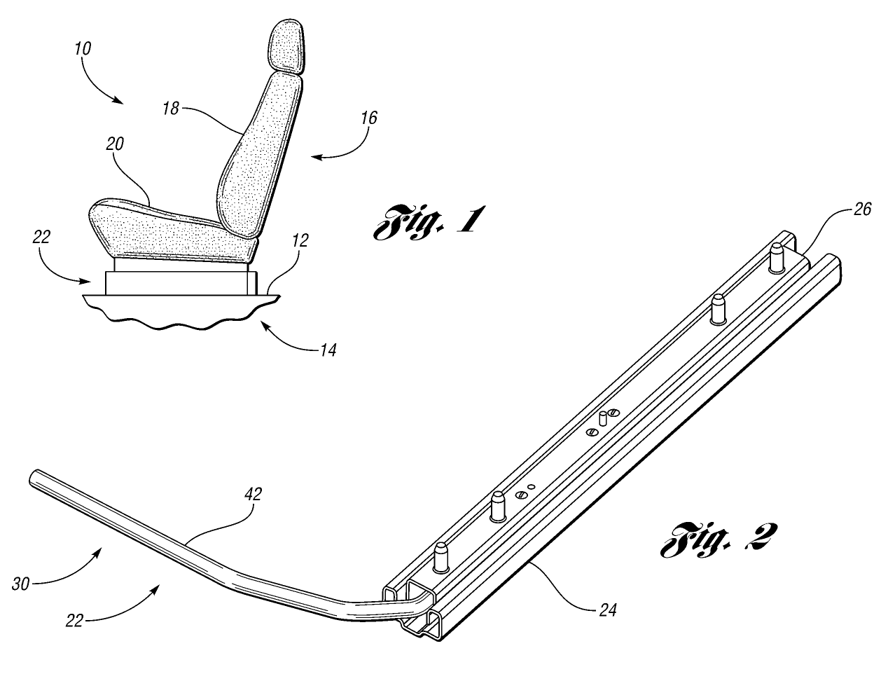

FIG. 1 shows a vehicle seat assembly 10 mounted on a floor 12 of a vehicle 14. The assembly 10 includes a vehicle seat 16 having a seat back 18 that may be movably attached, such as pivotally attached, or fixedly attached to a seat bottom 20. The assembly 10 further includes a longitudinal seat adjustment apparatus 22 that supports the seat 16 and that is attached to the floor 12 or other portion of the vehicle 14.

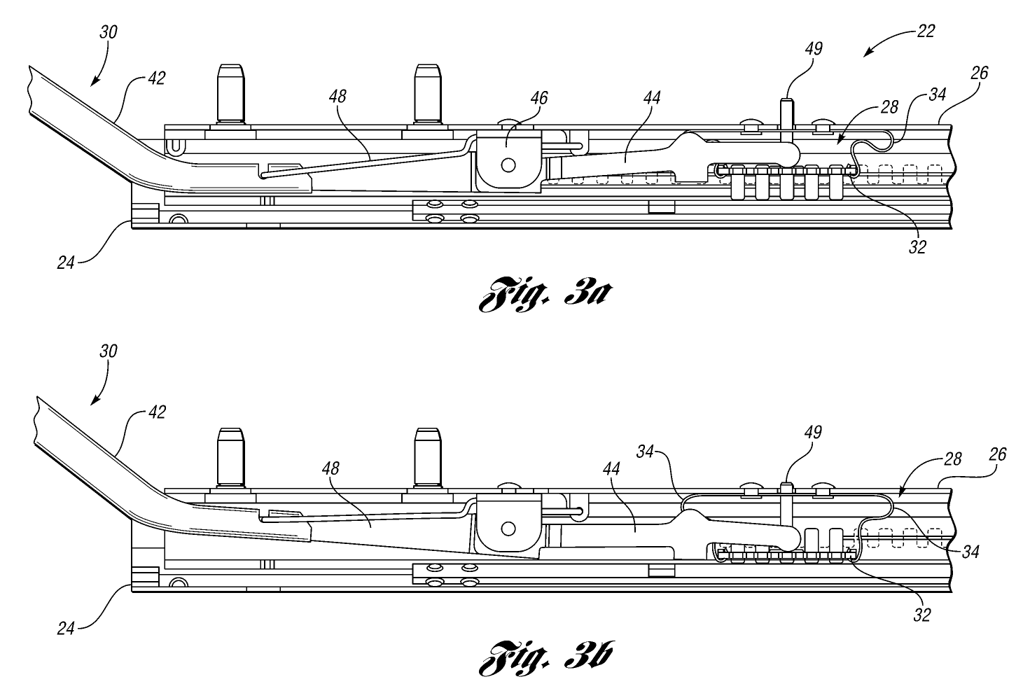

The seat adjustment apparatus 22 is configured to allow the seat 16 to be positioned in one or more longitudinal use positions. Referring to FIGS. 2-3b, the seat adjustment apparatus 22 includes a first seat support member, such as a lower rail 24, that is attachable to the vehicle 14, and a second seat support member, such as an upper rail 26, that is attached to the seat bottom 20 and movable longitudinally with respect to the lower rail 24. Although only one set of seat support members is shown in FIG. 2, it is to be understood that the seat adjustment apparatus 22 may include any suitable number of support members, such as one set of seat support members on each side of the seat bottom 20.

The seat adjustment apparatus 22 further includes a locking device 28 for locking the seat 16 in one or more use positions, such as multiple incremental use positions. In addition, the seat adjustment apparatus 22 includes a release mechanism 30 for unlocking the locking device 28 so that the seat 16 and upper rail 26 may be moved longitudinally with respect to the lower rail 24.

In the embodiment shown in FIGS. 3a and 3b, the locking device 28 includes a locking member 32 that is supported on the upper rail 26 such that the locking member 32 is movable generally vertically with respect to the rails 24 and 26 between a locked position, shown in FIG. 3a, and an unlocked position, shown in 3b. For example, the locking member 32 may be supported by one or more flexible spring members 34 that are attached to the upper rail 26. As another example, referring to FIG. 4, the locking member 32 may be supported by a support member, such as a pin 36, that extends through a U-shaped bracket 38 that is attached to the upper rail 26. In this embodiment, a coil spring 40 is disposed between the bracket 38 and a shoulder 41 on the pin 36, such that the spring 40 urges the locking member 32 upwardly. As explained below in detail, the locking member 32 is configured to cooperate with one or more lock portions formed in the rails 24 and 26 to lock the upper rail 26 with respect to the lower rail 24 in a desired longitudinal position.

In the embodiment shown in FIGS. 3a and 3b, the locking member 32 is generally planar. Furthermore, in that embodiment, the locking member 32 remains generally horizontal as the locking member 32 moves between the locked and unlocked positions.

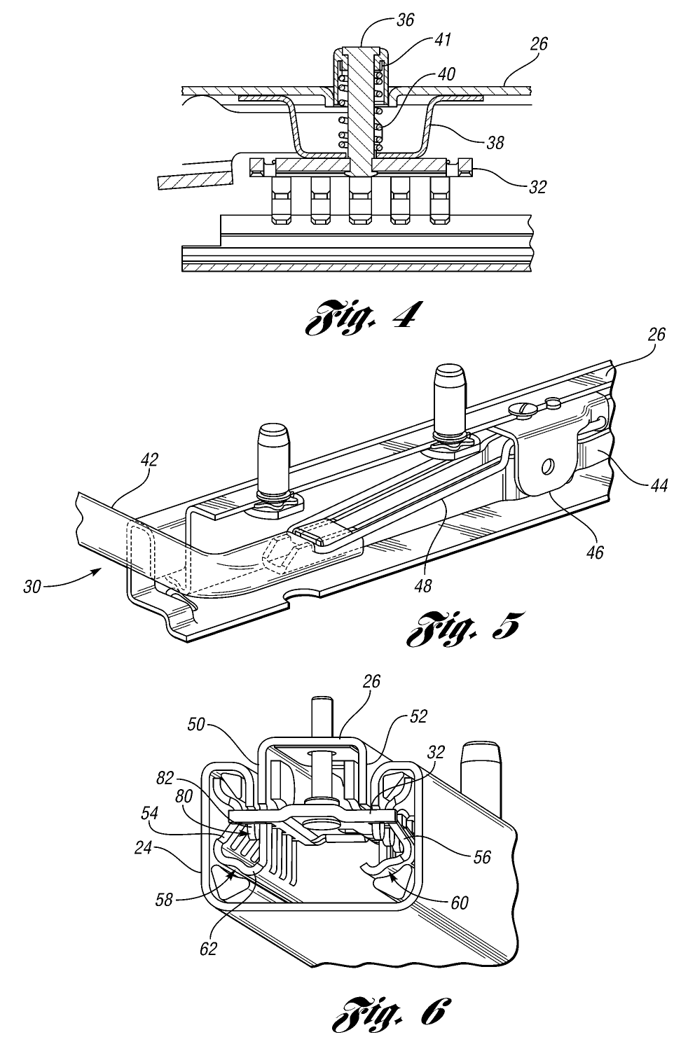

The release mechanism 30 may have any suitable configuration for unlocking the locking device 28. In the embodiment shown in FIGS. 3a, 3b and 5, for example, the release mechanism 30 includes an external release member, such as bar 42, connected to an internal release lever 44 that is pivotally connected to the upper rail 26 by a bracket 46. Referring to FIG. 3b, when the bar 42 is raised upwardly, the release lever 44 pivots clockwise and unlocks the locking member 32 from the lower rail 24. The release mechanism 30 may also include a spring member 48 that urges the release lever 44 counterclockwise and the bar 42 downward.

As another example, the seat adjustment apparatus 22 may be provided with a release mechanism (not shown) that is configured to push down on a pin 49 (or pin 36 in the embodiment shown in FIG. 4) connected to the locking member 32 and that extends through the upper rail 26, to thereby move the locking member 32 vertically with respect to the upper rail 26. As yet another example, such a release mechanism may be provided along with the release mechanism 30.

Referring to FIGS. 6 and 7, additional details of the rails 24 and 26 and locking member 32 will now be discussed. The upper rail 26 may be configured to slide relative to the lower rail 24 with the assistance of multiple rollers 51 disposed between the rails 24 and 26. While the rails 24 and 26 may have any suitable construction, in the embodiment shown in FIGS. 6 and 7, the upper rail 26 has first and second substantially planar inner walls 50 and 52, respectively, and first and second outer walls 54 and 56, respectively, disposed outwardly of the inner walls 50 and 52. The upper rail 26 further includes a first generally laterally extending section 58 that extends between the first inner wall 50 and the first outer wall 54, and a second generally laterally extending section 60 that extends between the second inner wall 52 and the second outer wall 56. Each section 58 and 60 includes a bent portion 62 disposed beneath a respective inner wall 50, 52.

Each inner wall 50 and 52 has a first lock portion 64, and each outer wall 54 and 56 has a second lock portion 66 that faces a respective first lock portion 64. Each first lock portion 64 may include one or more first openings 68 that are each substantially formed in the associated inner wall 50, 52, such that each first opening 68 is substantially planar. Furthermore, each first opening 68 is substantially located above the associated bent portion 62. As a result, the upper rail 26 may exhibit significant strength.

In one embodiment, for example, at least 80% of each first opening 68 may be located above the associated bent portion 62, wherein the above percentage is calculated by dividing the height of each first opening 68 above the bent portion 62 by the maximum height of the first opening 68. In another embodiment, at least 85% of each first opening 68 may be located above the associated bent portion 62. For example, approximately 87% of each first opening 68 may be located above the associated bent portion 62. In yet another embodiment, at least 90% of each first opening 68 may be located above the associated bent portion 62. In still yet another embodiment, at least 95% of each first opening 68 may be located above the associated bent portion 62. In the embodiment shown in FIG. 7, each first opening 68 is entirely located above the associated bent portion 62.

Each second lock portion 66 may include one or more second openings 70 that are aligned with the first openings 68. As shown in FIG. 7, the openings 68 and 70 are spaced laterally apart from each other such that none of the second openings 70 overlap the first openings 68 when the upper rail 26 is viewed in cross section.

The lower rail 24 has first and second substantially planar inner walls 72 and 74, respectively, and first and second substantially planar outer walls 76 and 78, respectively. Each inner wall 72 and 74 has a third lock portion 80 that is located between respective first and second lock portions 64 and 66, respectively, of the upper rail 26. Furthermore, each third lock portion 80 may include one or more third openings 82, such as notches.

When the locking member 32 is in the locked position (shown in solid lines in FIG. 7), each side of the locking member 32 extends into respective first, second and third locking portions 64, 66 and 80, respectively. Furthermore, in the embodiment shown in FIG. 7, each side of the locking member 32 does not extend into a respective third lock portion 80 when the locking member 32 is in the unlocked position (shown in dashed lines in FIG. 7). Each side of the locking member 32 may also not extend into a respective second lock portion 66 when the locking member 32 is in the unlocked position.

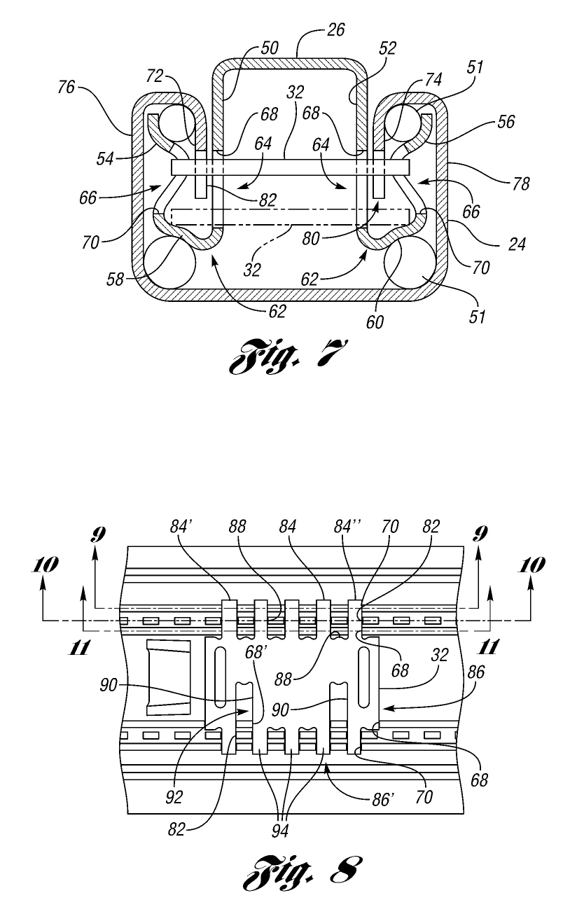

Referring to FIG. 8, the locking member 32 may include one or more first lock features 84, such as teeth or other projections, that extend into openings 68, 70 and 82 on one side of the locking member 32, and one or more second lock features 86 that extend into openings 68, 70 and 82 on the other side of the locking member 32 when the locking member 32 is in the locked position. In the embodiment shown in FIG. 8, the locking member 32 includes multiple first openings, such as recesses or slots 88, that define the first lock features 84, and multiple second openings, such as recesses or slots 90, that define the second lock features 86. In the embodiment shown in FIG. 8, each first slot 88 has a first length L1 and each second slot 90 has a second length L2 that is substantially larger than each first length L1 to facilitate assembly of the locking member 32 onto the upper rail 26, as explained below in detail. For example, each second length L2 may be at least thirty percent larger than each first length L1. As another example, each second length L2 may be at least fifty percent larger than each first length L1. In the embodiment shown in FIG. 8, each second length L2 is more than seventy-five percent larger than each first length L1. Furthermore, each second length L2 may be at least one third of the width W of the locking member 32. In the embodiment shown in FIG. 8, for example, each second length L2 is greater than forty percent of the width W.

In the embodiment shown in FIG. 8, each second lock feature 86 includes a main portion that extends into a first opening 68 of the first lock portion 64, and one or more narrower projections, such as teeth, that each extend into relatively smaller openings in the second and third lock portions 66 and 80, respectively, when the locking member 32 is in the locked position. For example, one of the second lock 30 features 86′ may include a main portion 92 that extends into a first opening 68′ of the first lock portion 64, and multiple projections 94 that each extend from the main portion 92 and into a respective second opening 70 of the second lock portion 66 and a respective third opening 82 of the third lock portion 80. Furthermore, each opening 70 and 82 that receives a projection 94 associated with a particular main portion 92 is aligned with the respective first opening 68′ that receives the main portion 92.

With the above configuration, the locking member 32 may maintain sufficient strength while also permitting efficient assembly of the locking member 32 onto the upper rail 26. For example, because of the relatively long second slots 90 and the configuration of the upper rail 26, the second lock features 86 of the locking member 32 may first be inserted at an angle into the corresponding first and second lock portions 64 and 66, respectively, and then the locking member 32 may be tilted to insert the first lock features 84 into the corresponding first and second lock portions 64 and 66, respectively, located on the opposite side of the upper rail 26. The lower rail 24 may then be assembled onto the upper rail 26.

Furthermore, because each side of the locking member 32 may extend into three lock portions 64, 66 and 80, significant locking strength may be achieved. In the embodiment shown in FIG. 8, for example, each lock feature 84, 86 may be clamped by three lock portions 64, 66 and 80 during a crash event, thereby reducing bending moment.

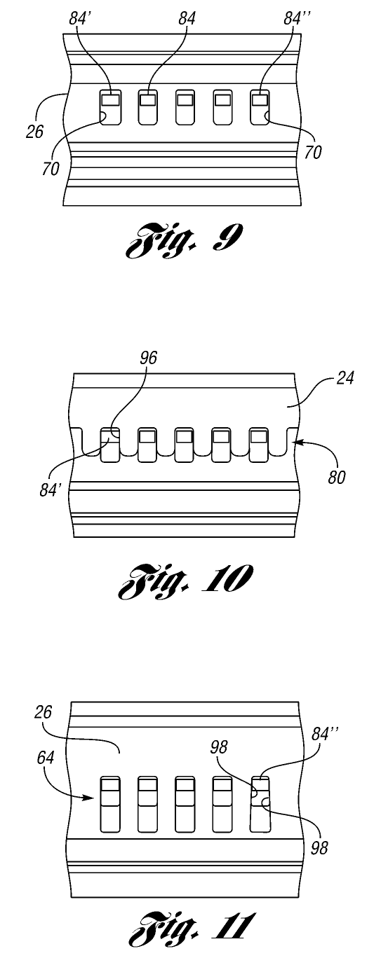

The seat adjustment apparatus 22 may also be configured to reduce or eliminate free play in any suitable manner. For example, the leftmost first lock feature 84′ shown in FIG. 8 may be wider than the other first lock features 84, such that the leftmost first lock feature 84′ engages side walls 96 of the third lock portion 80 of the lower rail 24, as shown in FIG. 10, when the locking member 32 is in the locked position to thereby eliminate free play between the locking member 32 and the lower rail 24. In another embodiment, the third openings 82 of the third lock portion 80 may each be wedge shaped (e.g., one or both of the side walls forming each third opening 82 may be angled) to facilitate engagement of the leftmost first lock feature 84′ with the third lock portion 80. Furthermore, referring to FIGS. 8 and 11, the rightmost first lock feature 84″ may engage angled side walls 98 of the first lock portion 64 of the upper rail 26 when the locking member 32 is in the locked position to thereby eliminate free play between the locking member 32 and the upper rail 26. The locking member 32 may also be configured to tilt or rotate to enable the leftmost first lock feature 84′ to engage the lower rail 24 and the rightmost lock feature 84″ to engage the upper rail 26.

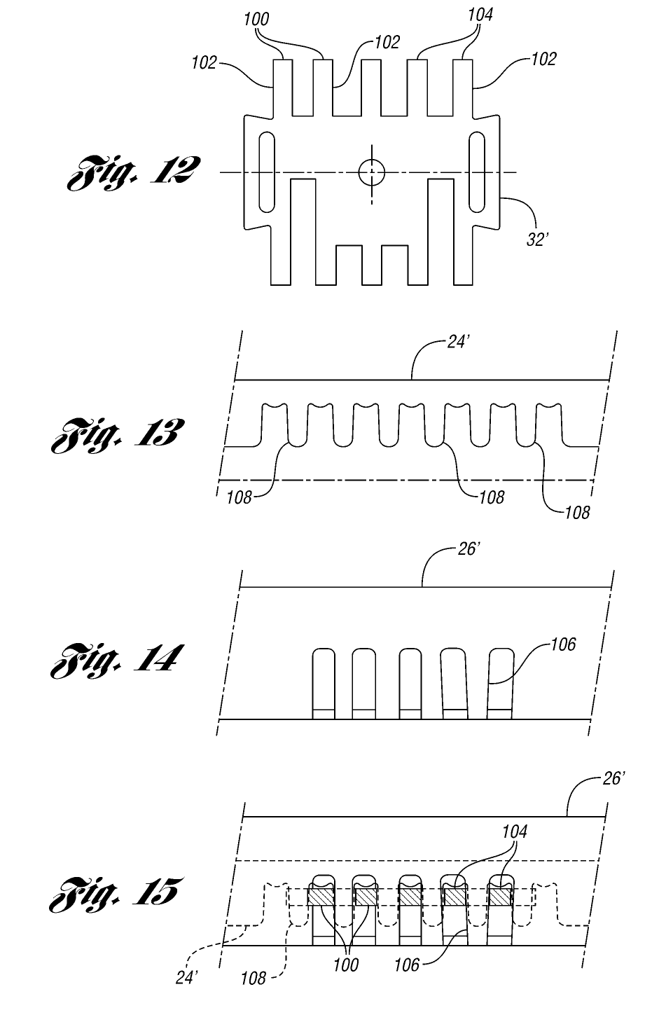

In another embodiment shown in FIGS. 12-15, a locking member 32′ may be provided with a first pair 100 of first lock features 102 having a first spacing or pitch, and a second pair 104 of first lock features 102 having a second spacing or pitch different than the first pitch. Referring to FIG. 15, the second pair 104 of first lock features 102 may engage a lock feature, such as a wedge bar 106 of a first or second lock portion, of an upper rail 26′ when the locking member 32′ is in the locked position to thereby eliminate free play between the locking member 32′ and the upper rail 26′. Furthermore, the first pair 100 of first lock features 102 may engage a lock feature, such as a tooth 108 of a third lock portion, of a lower rail 24′ when the locking member 32′ is in the locked position to thereby eliminate free play between the locking member 32′ and the lower rail 24′. The locking member 32′ may also be configured to tilt or rotate to enable the locking member 32′ to engage both the lower rail 24′ and the upper rail 26′.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. For example, while the upper rail 26 in the above embodiment is provided with first and second lock portions 64 and 66, respectively, on each side of the upper rail 26, a longitudinal seat adjustment apparatus in accordance with the invention may instead include a lower rail with multiple lock portions on each side of the lower rail.

What is claimed is:

1. A seat assembly for use with a vehicle, the seat assembly comprising:
a first support member that is attachable to the vehicle;
a second support member that is moveable with respect to the first support member;
a seat bottom supported by the second support member such that the seat bottom is movable with the second support member;
one of the support members having first and second lock portions that face each other, and the other support member having a third lock portion that is configured to be located between the first and second lock portions; and
a locking member that is movable generally vertically with respect to the support members between a locked position and an unlocked position for locking and unlocking the second support member with respect to the first support member, wherein the locking member extends into the first, second and third lock portions when the locking member is in the locked position.

2. The seat assembly of claim 1 wherein first lock portion includes an opening, and the second lock portion includes multiple openings that are each aligned with the opening of the first lock portion, and the locking member includes a lock feature having a main portion that extends into the opening of the first lock portion and multiple projections that extend from the main portion and into the multiple openings of the second lock portion when the locking member is in the locked position.

3. The seat assembly of claim 2 wherein the second lock portion includes at least three openings that are each aligned with the opening of the first lock portion, and the lock feature includes at least three projections that each extend from the main portion and into a respective one of the at least three openings of the second lock portion.

4. The seat assembly of claim 1 wherein the first and second lock portions are on a first side of the one support member, the one support member has fourth and fifth lock portions that face each other and that are disposed on a second side of the one support member opposite the first side, the other support member has a sixth lock portion that is configured to be located between the fourth and fifth lock portions, and the locking member extends into the fourth, fifth and sixth lock portions when the locking member is in the locked position.

5. The seat assembly of claim 4 wherein the locking member includes a first lock feature that extends into the first, second and third lock portions when the locking member is in the locked position, a first recess that at least partially defines the first lock feature, a second lock feature that extends into the fourth, fifth and sixth lock portions when the locking member is in the locked position, and a second recess that at least partially defines the second lock feature, and wherein the second support member is movable in a first direction with respect to the first support member, the recesses of the locking member each have a length oriented generally transverse to the first direction, and the length of the second recess is substantially larger than the length of the first recess to facilitate assembly of the locking member onto the one support member.

6. The seat assembly of claim 5 wherein the length of the second recess is at least fifty percent larger than the length of the first recess.

7. The seat assembly of claim 4 wherein the locking member includes multiple first lock features that extend into the first, second and third lock portions when the locking member is in the locked position, multiple second lock features that extend into the fourth, fifth and sixth lock portions when the locking member is in the locked position, and multiple slots that at least partially define at least one of the second lock features, and wherein the second support member is movable in a first direction with respect to the first support member, the locking member has a width oriented generally transverse to the first direction, the slots of the locking member each have a length oriented generally transverse to the first direction, and the length of each slot is at least one third of the width of the locking member to facilitate assembly of the locking member onto the one support member.

8. The seat assembly of claim 1 wherein the second support member is movable with respect to the first support member in a first direction, the first and second lock portions include first and second openings, respectively, that are sufficiently aligned with each other for receiving the locking member, and the openings are spaced laterally apart from each other such that neither opening overlaps the other opening when the one support member is viewed in cross-section in the first direction.

9. The seat assembly of claim 1 wherein the one support member includes an outer wall and a generally planar inner wall, and wherein the first lock portion includes an opening substantially formed in the generally planar inner wall such that the opening is generally planar, and wherein the opening receives at least part of the locking member when the locking member is in the locked position.

10. The seat assembly of claim 1 wherein the one support member includes an inner wall, an outer wall, and a bent portion disposed between the walls, wherein the first lock portion includes an opening formed in the inner wall such that the opening is substantially located above the bent portion, and wherein the opening receives at least part of the locking member when the locking member is in the locked position.

11. A seat assembly for use with a vehicle, the seat assembly comprising:
a first support member that is attachable to the vehicle;
a second support member that is movable with respect to the first support member in a first direction;
a seat bottom supported by the second support member such that the seat bottom is movable with the second support member;
one of the support members having first and second substantially planar inner walls, and first and second outer walls disposed outwardly of the inner walls, each inner wall having a first lock portion and each outer wall having a second lock portion that faces a respective first lock portion, each first lock portion including an opening substantially formed in the associated substantially planar inner wall such that the opening is substantially planar;
the other support member including opposite sides that each having a third lock portion that is located between respective first and second lock portions of the one support member; and
a locking member that is movable with respect to the support members in a direction generally transverse to the first direction between a locked position and an unlocked position for locking and unlocking the second support member with respect to the first support member, wherein the locking member includes opposite sides that each extend into respective first, second and third lock portions when the locking member is in the locked position, such that each side extends into the opening of the respective first lock portion.

12. The seat assembly of claim 11 wherein one of the second lock portions includes multiple openings that are each aligned with the opening of one of the first lock portions, and the locking member includes a lock feature having a main portion that extends into the opening of the one first lock portion and multiple projections that extend from the main portion and into the multiple openings of the one second lock portion when the locking member is in the locked position.

13. The seat assembly of claim 11 wherein the locking member includes a first lock feature formed on one side of the locking member and a second lock feature formed on the opposite side, such that each lock feature extends into respective first, second and third lock portions when the locking member is in the locked position, wherein the locking member further includes a first recess that at least partially defines the first lock feature, and a second recesses that at least partially defines the second lock feature, and wherein the recesses of the locking member each have a length oriented generally transverse to the first direction, and the length of the second recess is substantially larger than the length of the first recess to facilitate assembly of the locking member onto the second support member.

14. A longitudinal seat adjustment apparatus for 1 a vehicle seat, the adjustment apparatus comprising:
a first support member that is attachable to a vehicle;
a second support member that is moveable with respect to the first support member and configured to support the seat such that the seat is movable with the second support member;
one of the support members having first and second lock portions that face each other, and the other support member having a third lock portion that is configured to be located between the first and second lock portions; and
a locking member that is movable generally vertically with respect to the support members between a locked position and an unlocked position for locking and unlocking the second support member with respect to the first support member, wherein the locking member extends into the first, second and third lock portions when the locking member is in the locked position.

15. The apparatus of claim 14 wherein the first lock portion includes a first opening, and the second lock portion includes a second opening that is more narrow than the first opening, and the locking member includes a lock feature having a main portion that extends into the first opening of the first lock portion and a projection that extends from the main portion and into the second opening of the second lock portion when the locking member is in the locked position, the projection being more narrow than the main portion.

16. The apparatus of claim 14 wherein the first and second lock portions are on a first side of the one support member, the one support member has fourth and fifth lock portions that face each other and that are disposed on a second side of the one support member opposite the first side, the other support member has a sixth lock portion that is configured to be located between the fourth and fifth lock portions, and the locking member extends into the fourth, fifth and sixth lock portions when the locking member is in the locked position.

17. The apparatus of claim 16 wherein the locking 1 member includes a first lock feature that extends into the first, second and third lock portions when the locking member is in the locked position, a first recess that at least partially defines the first lock feature, a second lock feature that extends into the fourth, fifth and sixth lock portions when the locking member is in the locked position, and a second recess that at least partially defines the second lock feature, and wherein the second support member is movable in a first direction with respect to the first support member, the recesses of the locking member each have a length oriented generally transverse to the first direction, and the length of the second recess is substantially larger than the length of the first recess to facilitate assembly of the locking member onto the second support member.

18. The apparatus of claim 17 wherein the length of the second recess is at least thirty percent larger than the length of the first recess.

19. The apparatus of claim 14 wherein the second support member is movable with respect to the first support member in a first direction, the first and second lock portions include first and second openings, respectively, that are sufficiently aligned with each other for receiving the locking member, and the openings are spaced laterally apart from each other such that neither opening overlaps the other opening when the one support member is viewed in cross-section in the first direction.

20. The apparatus of claim 14 wherein the one support member includes an outer wall and a generally planar inner wall, and wherein the first lock portion includes an opening substantially formed in the generally planar inner wall such that the opening is generally planar.
